(19) United States
(12) Patent Application Publication
(10) Pub. No.: US 2020/0319541 A1
(43) Pub. Date: Oct. 8, 2020

(54) LIGHT SOURCE DEVICE AND PROJECTION DISPLAY APPARATUS

(71) Applicant: Panasonic Intellectual Property Management Co., Ltd., Osaka (JP)

(72) Inventor: Takaaki TANAKA, Osaka (JP)

(21) Appl. No.: 16/829,717

(22) Filed: Mar. 25, 2020

(30) Foreign Application Priority Data
Apr. 2, 2019 (JP) 2019-070476

(51) Int. Cl. G03B 21/20; H04N 9/31; G02B 27/14

(52) U.S. Cl. CPC G03B 21/204; G03B 21/2073; G03B 21/2066; G02B 27/141; H04N 9/3158; H04N 9/3164; H04N 9/3167

(57) ABSTRACT

A light source device includes: first and second light source elements which respectively generate blue and red lights; a first phase difference plate which controls a polarization component of the blue light; a first light combiner which combines the blue and the red lights, the blue light entering from the first phase difference plate; a second light combiner which the blue and the red light enter and which divides the blue light into first and second polarization components; a phosphor plate which generates yellow light by being excited by the first polarization component; and a second phase difference plate which controls polarization of the second polarization component and the red light. The second polarization component and the red light enter a reflective plate from the second phase difference plate, are reflected, enter the second light combiner again via the second phase difference plate, and are combined with the yellow light.

### BACKGROUND

### 1. Technical Field

The present disclosure is related to a light source device used as a light source in, for example, a projection display apparatus, and a projection display apparatus including the light source device.

### 2. Description of the Related Art

Conventionally, various light source devices have been disclosed which include long-life solid-state light-emitting elements, such as light-emitting diodes and semiconductor laser elements, as a light source for a projection display apparatus including a light modulator, such as a digital micromirror device (DMD) or a liquid crystal panel.

Patent Literature (PTL) 1 discloses a light source device with a high brightness and a low noise achieved by using a solid-state light source which has a long life and does not require mercury.

[PTL 1] Japanese Patent No. 5979416

[PTL 2] International Publication No. WO2017/061170

[PTL 3] Japanese Unexamined Patent Application Publication No. 2012-242449

### SUMMARY

In order to more closely reproduce the color of an object in an image projected by a projection apparatus, a light source device is required which is capable of generating output light with a wider color gamut.

The present disclosure provides a light source device which has a reduced size and is capable of generating output light with a wider color gamut compared with a conventional technique.

According to one aspect of the present disclosure, a light source device includes: a first light source element which generates blue light; a second light source element which generates red light; a first phase difference plate which controls a polarization component of the blue light; a first light combiner which combines the blue light and the red light, the blue light entering from the first light source element via the first phase difference plate, the red light entering from the second light source element; a second light combiner which the blue light and the red light combined by the first light combiner enter, the second light combiner dividing the blue light into a first polarization component and a second polarization component of the blue light; a phosphor plate which generates yellow light by being excited by the first polarization component of the blue light; a second phase difference plate which controls polarization of the second polarization component of the blue light and the red light; and a reflective plate which reflects incident light. The second polarization component of the blue light and the red light enter the reflective plate from the second light combiner via the second phase difference plate, are reflected by the reflective plate, enter the second light combiner again via the second phase difference plate, and are combined with the yellow light.

According to one aspect of the present disclosure, the light source device has a reduced size and is capable of generating output light with a wider color gamut compared with a conventional technique.

### BRIEF DESCRIPTION OF THE DRAWINGS

FIG. 1 schematically illustrates a configuration of light source device 100 according to a first embodiment.

FIG. 2 illustrates a configuration of first phase difference plate 28 in

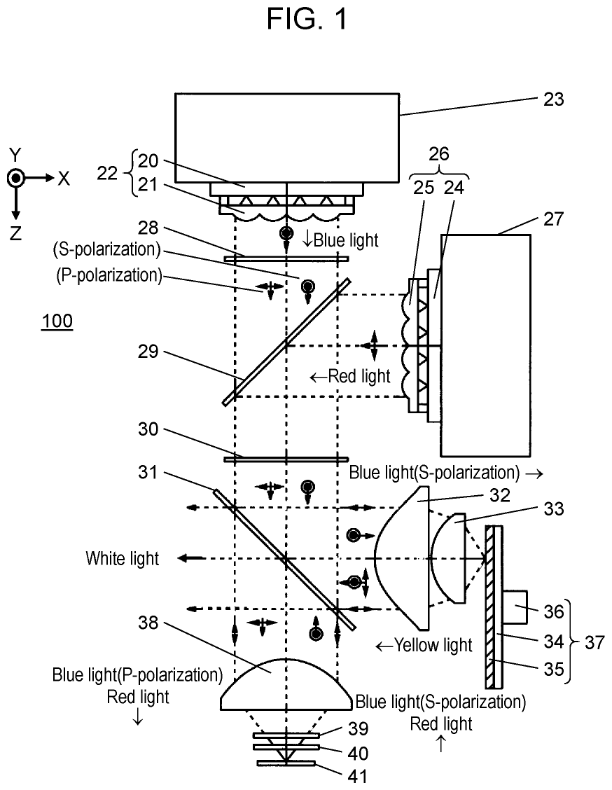

FIG. 1.

FIG. 3 is a graph of spectral characteristics of second dichroic mirror 31 in FIG. 1.

FIG. 4 is a graph of spectral characteristics of output light of light source device 100 in FIG. 1.

FIG. 5 schematically illustrates a configuration of projection display apparatus 120 according to a second embodiment.

FIG. 6 schematically illustrates a configuration of projection display apparatus 130 according to a third embodiment.

### DETAILED DESCRIPTION

Hereinafter, embodiments will be described in detail with reference to the drawings appropriately. However, unnecessarily detailed descriptions may be omitted. For example, detailed description of well-known matter or repeated description of essentially similar elements may be omitted. This is to avoid unnecessary redundancy and make the following description easier for those skilled in the art to understand.

Note that the accompanying drawings and following description are provided in order to facilitate sufficient understanding of the present disclosure for those skilled in the art, and as such, are not intended to limit the subject matter described in the claims.

### First Embodiment

### [1-1. Configuration]

FIG. 1 schematically illustrates a configuration of light source device 100 according to a first embodiment. Light source device 100 includes: blue light source unit 22; heat dissipation plate 23; red light source unit 26; heat dissipation plate 27; first phase difference plate 28; first dichroic mirror 29; first diffuser plate 30; second dichroic mirror 31; condenser lenses 32, 33, and 38; phosphor wheel device 37; second diffuser plate 39; second phase difference plate 40; and reflective plate 41.

FIG. 1 also illustrates the polarization components (p-polarization component or s-polarization component) of light entering first dichroic mirror 29 from blue light source unit 22 and red light source unit 26 and the polarization components (p-polarization component or s-polarization component) of light entering and exiting second dichroic mirror 31.

Blue light source unit 22 includes blue light source element 20 and lens array 21. Blue light source element 20 includes an array of a plurality of blue semiconductor laser elements, for example, twenty (four×five) blue semiconductor laser elements arranged on a substrate. Each of the blue semiconductor laser elements generates linearly polarized blue light having a wavelength of, for example, 455 nm±10 nm. Lens array 21 includes a plurality of collimating lenses positioned above the corresponding blue semiconductor laser elements of blue light source element 20. Each collimating lens converts the light generated by the corresponding blue semiconductor laser element into parallel light.

Heat dissipation plate 23 is in contact with blue light source element 20 so that heat can be conducted, and cools down blue light source element 20.

Red light source unit 26 includes red light source element 24 and lens array 25. Red light source element 24 includes an array of a plurality of red semiconductor laser elements, for example, twenty (four×five) red semiconductor laser elements arranged on a substrate. Each of the red semiconductor laser elements generates linearly polarized red light having a wavelength of, for example, 640 nm±10 nm. Lens array 25 includes a plurality of collimating lenses positioned above the corresponding red semiconductor laser elements of red light source element 24. Each collimating lens converts the light generated by the corresponding red semiconductor laser element into parallel light.

Heat dissipation plate 27 is in contact with red light source element 24 so that heat can be conducted, and cools down red light source element 24.

The blue light generated by blue light source unit 22 enters one of the surfaces of first dichroic mirror 29 via first phase difference plate 28. The red light generated by red light source unit 26 enters the other surface of first dichroic mirror 29. Blue light source unit 22 is arranged such that the blue light entering first dichroic mirror 29 from blue light source unit 22 via first phase difference plate 28 has an s-polarization component relative to the incidence plane of first dichroic mirror 29. Red light source unit 26 is arranged such that the red light entering first dichroic mirror 29 from red light source unit 26 has a p-polarization component relative to the incidence plane of first dichroic mirror 29.

First phase difference plate 28 controls the polarization components by changing the polarization state of the incident light. First phase difference plate 28 is, for example, a ¼ waveplate which generates a phase difference of ¼ wavelength between the mutually orthogonal polarization components near the emission center wavelength (for example, 455 nm) of each blue semiconductor laser element of blue light source element 20. First phase difference plate 28 is capable of adjusting (that is, controlling) the ratio of the s-polarization component to the p-polarization component relative to the incidence plane of the posterior-located first dichroic mirror 29 by adjusting the angle of the optical axis of first phase difference plate 28.

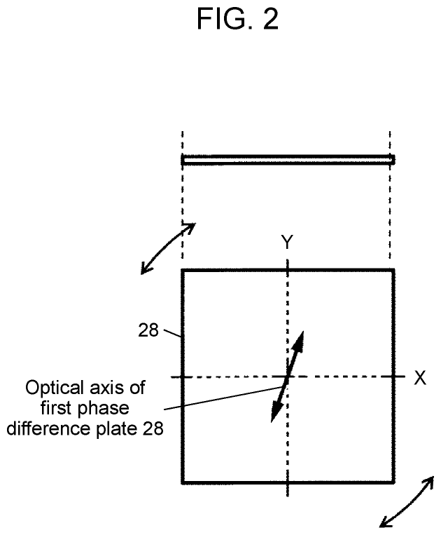

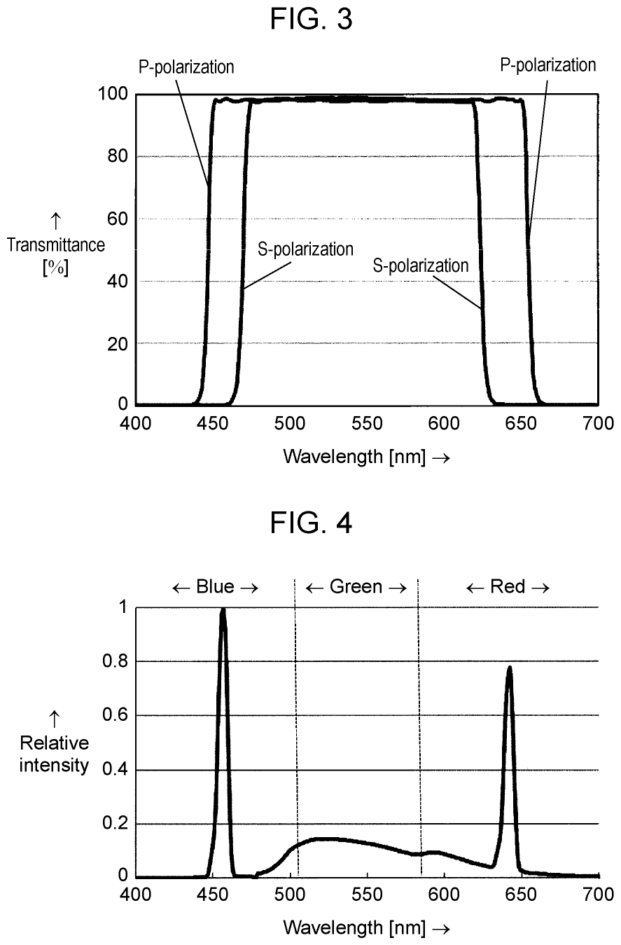

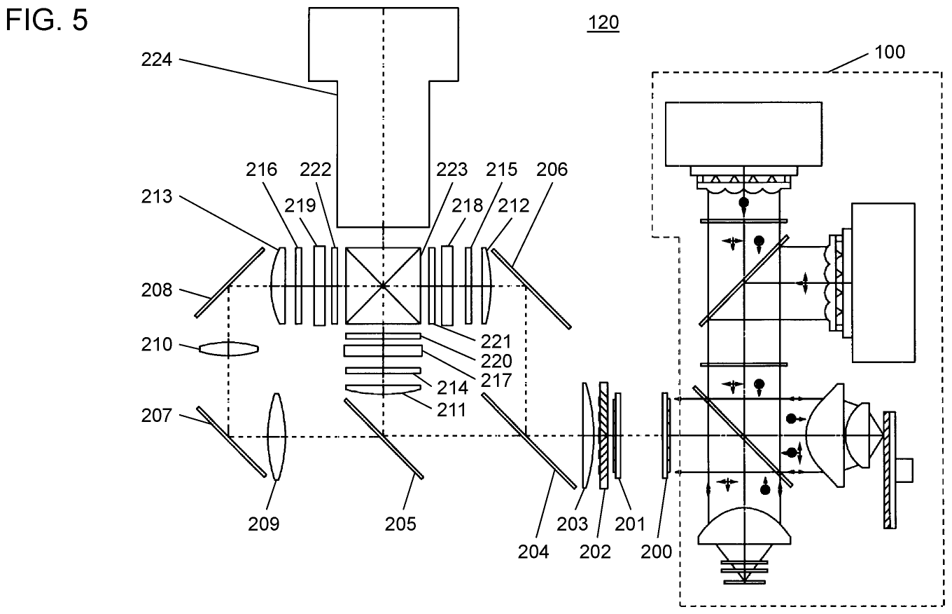

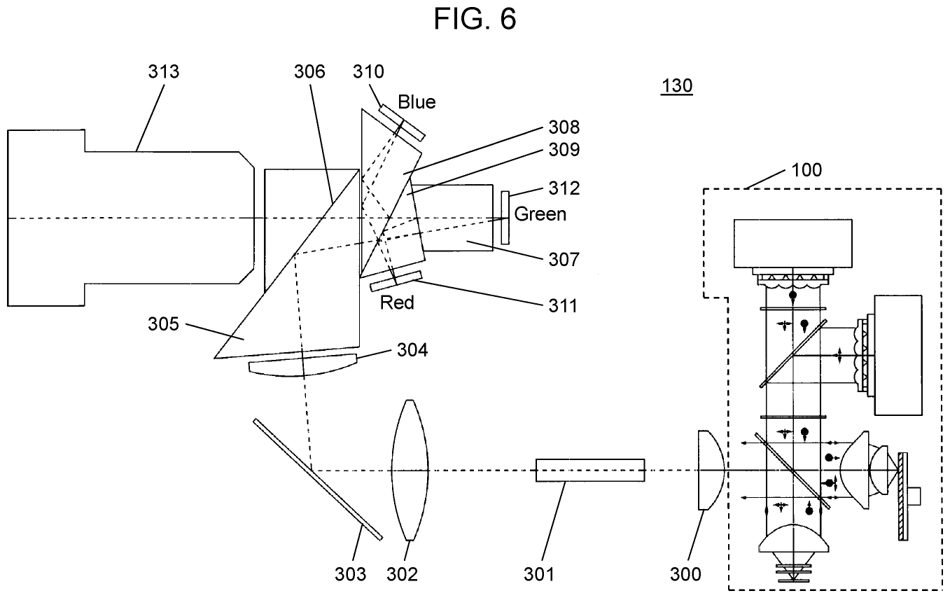

FIG. 2 illustrates a configuration of first phase difference plate 28 in FIG. 1. First phase difference plate 28 is rotatably supported about the optical axis (that is, the axis parallel to Z-axis in FIG. 1) extending from blue light source element 20 to first dichroic mirror 29. The optical axis of first phase difference plate 28 is arranged, for example, so as to have an angle of 70.4 degrees relative to the X-axis in FIG. 1. Here, first phase difference plate 28 converts the s-polarized incident light (that is, incident light having a vibration direction of the electric vector parallel to the YZ plane) into light including an approximately 80% s-polarization component and an approximately 20% p-polarization component. By rotating first phase difference plate 28, the ratio of the p-polarization component to the s-polarization component of light can be adjusted. First phase difference plate 28 may be manually rotated, or may be rotated by a rotary mechanism including a motor or the like. First phase difference plate 28 may be rotated over a predetermined angle range, for example, approximately ±five degrees.

First phase difference plate 28 includes, for example, a substrate having an uneven pattern formed so as to generate birefringence. First phase difference plate 28 includes, on a glass substrate, a minute periodic structure smaller than the light wavelength, and generates a phase difference by using the birefringence generated by the minute periodic structure. First phase difference plate 28 with the minute periodic structure is formed by an inorganic material by using, for example, a nanoimprint method, and has excellent durability and reliability in a similar manner to an inorganic optical crystal such as crystals.

First phase difference plate 28 may be configured as disclosed in, for example, Patent Literature (PTL) 2. PTL 2 discloses an optical phase difference component which generates a phase difference in incident light. The optical phase difference component includes: a transparent substrate having an uneven pattern formed of a plurality of protrusions which extend in one direction and have a substantially trapezoidal sectional shape in a plane vertical to the extension direction; a first layer disposed over the top and lateral surfaces of the protrusions on the transparent substrate; and a second layer disposed over the first layer on the top surfaces of the protrusions. An air layer exists between the first layers on the opposing lateral surfaces of adjacent protrusions. The first layer has a refractive index greater than the refractive index of the protrusions and the refractive index of the second layer.

First dichroic mirror 29 combines the blue light entering from blue light source element 20 via first phase difference plate 28 and the red light entering from red light source element 24. First dichroic mirror 29 have characteristics of transmitting the p-polarization component and the s-polarization component of the blue light having a wavelength of 455 nm±10 nm at a high transmittance of 96% or greater, and reflecting the p-polarization component of the red light having a wavelength of 640 nm±10 nm at a high reflectance of 97% or greater. Hence, first dichroic mirror 29 transmits the blue light entering from blue light source element 20 via first phase difference plate 28 and reflects the red light entering from red light source element 24, so that the blue light and the red light are combined. The light exiting first dichroic mirror 29 including the blue light and the red light enters first diffuser plate 30.

First dichroic mirror 29 is an example of a light combiner.

First diffuser plate 30 is made of glass, and has a surface with fine irregularities or microlens shape, so as to diffuse incident light. First diffuser plate 30 has a sufficiently small diffusion angle (that is, a half-value angular width which indicates an angular width of light having a half intensity relative to the maximum intensity of the diffused light), for example, a diffusion angle of approximately four degrees, such that the light exiting first diffuser plate 30 maintains the polarization characteristics of the incident light. The light exiting first diffuser plate 30 enters second dichroic mirror 31.

Second dichroic mirror 31 reflects the s-polarization component of the blue light entering from first diffuser plate 30, and transmits the p-polarization component of the blue light. By doing so, second dichroic mirror 31 divides the blue light included in the light exiting first dichroic mirror 29 into the s-polarization component and the p-polarization component. Moreover, second dichroic mirror 31 transmits the p-polarization component of the red light included in the light exiting first dichroic mirror 29.

FIG. 3 is a graph of spectral characteristics of second dichroic mirror 31 in FIG. 1. The spectral characteristics in FIG. 3 represent the transmittance with respect to the wavelength. Second dichroic mirror 31 has characteristics of transmitting the p-polarization component of blue light having a wavelength of 455 nm±10 nm and the p-polarization component of red light having a wavelength of 640 nm±10 nm, and reflecting the s-polarization components of the blue light and the red light at a high reflectance. Moreover, second dichroic mirror 31 has characteristics of transmitting the p-polarization component and the s-polarization component of green light having a wavelength of 480 nm to 610 nm and red light at a high transmittance of 96% or greater.

The s-polarized blue light entering second dichroic mirror 31 from first diffuser plate 30 and reflected by second dichroic mirror 31 is condensed by condenser lenses 32 and 33, and enters phosphor wheel device 37. When the diameter of a region having a light intensity of 13.5% relative to the maximum value of light intensity is defined as a spot diameter, the light entering phosphor wheel device 37 enters the region having a spot diameter of 1.5 mm to 2.5 mm. First diffuser plate 30 diffuses light such that the spot diameter of the light entering phosphor wheel device 37 becomes a desired value.

Phosphor wheel device 37 includes circular substrate 34, phosphor layer 35, and motor 36. Circular substrate 34 is made of, for example, aluminum. A reflective coat, which is a metal coat or a dielectric coat, which reflects visible light is disposed on circular substrate 34. Moreover, phosphor layer 35 is disposed on the reflective coat in an annular shape. A Ce-activated YAG yellow phosphor, which is excited by blue light, for example, and generates yellow light including color components of green light and red light, is disposed on phosphor layer 35. Examples of a typical chemical composition of the crystal matrix of the phosphor is Y₃A₁₅O₁₂. Phosphor layer 35 generates yellow light including color components of green light and red light by being excited by the blue light entering from second dichroic mirror 31. Motor 36 rotates circular substrate 34. Rotation of circular substrate 34 moves the position on phosphor layer 35 where the blue light from second dichroic mirror 31 enters. This reduces the temperature rise of phosphor layer 35 caused by excitation with the blue light, and allows the phosphor conversion rate to be steadily maintained. Part of the light generated by phosphor layer 35 travels in the negative direction of X-axis, and another part of the light travels in the positive direction of X-axis and is reflected by the reflective layer in the negative direction of X-axis.

The yellow light exiting phosphor wheel device 37 (that is, the yellow light including green light and red light) becomes natural light, is condensed by condenser lenses 33 and 32 again, is converted into substantially parallel light, and passes through second dichroic mirror 31.

In contrast, the p-polarization components of the blue light and the red light entering second dichroic mirror 31 from first diffusor plate 30, and passing through second dichroic mirror 31 enter condenser lens 38 and are condensed by condenser lens 38. The focal length of condenser lens 38 is set such that the condensed spot is formed near reflective plate 41. The light exiting condenser lens 38 enters second diffusor plate 39.

Second diffuser plate 39 is made of glass, and has a surface with fine irregularities or microlens shape, so as to diffuse the incident light. Second diffuser plate 39 diffuses the incident light, makes the light intensity distribution uniform, and removes the speckle noise of the laser light. Second diffusor plate 39 has a sufficiently small diffusion angle, for example, approximately four degrees, such that the light exiting second diffusor plate 39 maintains the polarization characteristics of the incident light. The light exiting second diffusion plate 39 enters second phase difference plate 40.

Second phase difference plate 40 controls the polarization components by changing the polarization state of the incident light. Second phase difference plate 40 is a ¼ waveplate which generates a phase difference of ¼ wavelength between the mutually orthogonal polarization components over a band including, for example, blue light and red light. The optical axis of second phase difference plate 40 is arranged so as to have an angle of 45 degrees relative to the direction of the p-polarization component, for example, and changes the p-polarized incident light into circularly polarized outgoing light. The light exiting second phase difference plate 40 enters reflective plate 41.

Second phase difference plate 40 includes, for example, a substrate, and a thin coat made of a dielectric material obliquely vapor-deposited on the surface of the substrate so as to generate birefringence. Second phase difference plate 40 including an obliquely vapor-deposited thin coat is made of an inorganic material, and has excellent durability and reliability in a similar manner to an inorganic optical crystal such as crystals. Moreover, second phase difference plate 40 including the obliquely vapor-deposited thin coat is capable of forming a thick coat relatively easily, and is capable of forming a wide-band ¼ waveplate.

Second phase difference plate 40 may be configured as disclosed in, for example, Patent Literature (PTL) 3. PTL 3 discloses a phase difference element which includes: a transparent substrate; an obliquely vapor deposited multi-layer coat formed by a plurality of layers of a dielectric material, the layers of the dielectric material being alternately vapor deposited from two directions differing by 180 degrees from each other, with the thicknesses of the respective layers being not greater than the wavelength of light in use; and an interface anti-reflection coat composed by one or more of alternately high and low refractive index coats stacked between the transparent substrate and the obliquely vapor deposited multi-layer coat, the refractive index of the interface anti-reflection coat group being higher than the refractive index of the transparent substrate and lower than the refractive index of the obliquely vapor deposited coat.

A reflective coat, such as aluminum or dielectric multi-layer coat, is disposed on reflective plate 41. By the light entering reflective plate 41 from second phase difference plate 40 being reflected by reflective plate 41, the phase of the light is inverted. Accordingly, the circularly polarized incident light becomes reversed circularly polarized reflected light. The light reflected by reflective plate 41 enters second phase difference plate 40 again, and is converted to the s-polarization component from the circular polarization by second phase difference plate 40. Then, the light exiting second phase difference plate 40 is diffused by second diffuser plate 39 again. The light exiting second diffusor plate 39 is converted into parallel light by condenser lens 38, and the light exiting condenser lens 38 enters second dichroic mirror 31. Since the light entering second dichroic mirror 31 (that is, blue light and red light) from condenser lens 38 has an s-polarization component, the light is reflected by second dichroic mirror 31.

Second dichroic mirror 31, second phase difference plate 40, and reflective plate 41 are arranged such that the p-polarization component of the blue light entering second dichroic mirror 31 from first diffuser plate 30 and the red light entering second dichroic mirror 31 from first diffuser plate 30 enter reflective plate 41 from second dichroic mirror 31 via second phase difference plate 40, are reflected by reflective plate 41, enter second dichroic mirror 31 again via second phase difference plate 40, and are combined with yellow light.

The yellow light, entering second dichroic mirror 31 from phosphor wheel device 37 and passing through second dichroic mirror 31, and the blue light and the red light, entering second dichroic mirror 31 from reflective plate 41 and being reflected by second dichroic mirror 31, are combined into white light. In other words, second dichroic mirror 31 combines: the yellow light which is generated by exciting phosphor wheel device 37 by the s-polarization component of the blue light entering second dichroic mirror 31 from first diffusor plate 30; the p-polarization component of the blue light entering second dichroic mirror 31 from first diffusor plate 30; and the red light included in the light exiting first dichroic mirror 29. Light source device 100 outputs the combined white light.

Second dichroic mirror 31 is an example of a light combiner.

### [1-2. Operation]

FIG. 4 is a graph of spectral characteristics of output light of light source device 100 in FIG. 1. By dividing each color component light by the dashed lines in FIG. 4, three primary-color light of blue, green and red with a high color purity can be obtained. The output light of light source device 100 has such spectrum characteristics. Accordingly, even if the output light of light source device 100 is divided by the optical system of a projection display apparatus to be described later into three primary-color light of blue, green, and red, monochromatic light with a high color purity can be obtained.

Moreover, output light with wide color gamut spectral characteristics can be obtained by using the blue light generated by each blue semiconductor laser element of blue light source element 20 and the red light generated by each red semiconductor laser element of red light source element 24.

Moreover, by rotating first phase difference plate 28, the ratio of the p-polarization component to the s-polarization component of the blue light entering second dichroic mirror 31 from first diffusor plate 30 can be adjusted. Accordingly, it is possible to adjust the ratio of the blue light traveling from second dichroic mirror 31 to phosphor wheel device 37 to the blue light traveling from second dichroic mirror 31 to reflective plate 41, and to adjust the ratio of the blue light to the yellow light (that is, yellow light including green light and red light) included in the white light output from light source device 100. Accordingly, by rotating first phase difference plate 28, the white balance of the output light of light source device 100 can be adjusted.

Moreover, light source device 100 combines the blue light and the red light by using first dichroic mirror 29, then divides respective polarization components of the blue light by using second dichroic mirror 31, and combines the yellow light generated by phosphor wheel device 37 and the blue light and the red light by using second dichroic mirror 31. The p-polarization component of the blue light entering second dichroic mirror 31 from first diffusor plate 30 and the red light entering second dichroic mirror 31 from first diffusor plate 30 are condensed and paralleled by condenser lens 38, and diffused by second diffusor plate 39. Accordingly, by using a common optical element, the p-polarization component of the blue light and the red light can be efficiently made uniform while reducing the speckle noise and brightness unevenness.

As described above, according to the first embodiment, it is possible to provide light source device 100 which has a reduced sized, and which outputs light with a higher color purity of the three primary colors of blue, green, and red and a wider color gamut compared with a conventional technique.

### [1-3. Variation]

First phase difference plate 28 may include a substrate, and a thin coat made of a dielectric material obliquely vapor-deposited on the surface of the substrate so as to generate birefringence. Moreover, light source device 100 may include first phase difference plate 28 made of crystal.

Moreover, blue light source unit 22 may be arranged such that the blue light entering first dichroic mirror 29 from blue light source unit 22 via first phase difference plate 28 has a p-polarization component relative to the incidence plane of first dichroic mirror 29. In this case, first phase difference plate 28 is a ½ waveplate which generates a phase difference of ½ wavelength between the mutually orthogonal polarization components near the emission center wavelength of each blue semiconductor laser element of blue light source element 20. In this case, too, by rotating first phase difference plate 28, the ratio of the p-polarization component to the s-polarization component of the blue light entering second dichroic mirror 31 from first diffusor plate 30 can be adjusted.

Second phase difference plate 40 may include a substrate having an uneven pattern formed so as to generate birefringence. Moreover, light source device 100 may include second phase difference plate 40 made of crystal.

Moreover, light source device 100 may include a plurality of blue light source units 22, and a plurality of red light source units 26. Moreover, light source device 100 may include one or more light source units which generate light of other color components.

### [1-4. Advantageous Effects Etc.]

According to the first embodiment, light source device 100 includes blue light source element 20 (corresponding to a first light source element), red light source element 24 (corresponding to a second light source element), first phase difference plate 28, phosphor wheel device 37 (an example of a phosphor plate), first dichroic mirror 29 (corresponding to a first light combiner), and second dichroic mirror 31 (corresponding to a second light combiner). Blue light source element 20 generates blue light. Red light source element 24 generates red light. Phosphor wheel device 37 generates yellow light by being excited by the blue light. First phase difference plate 28 controls the polarization components of incident light. First dichroic mirror 29 combines the blue light entering from blue light source element 20 via first phase difference plate 28 and the red light entering from red light source element 24. Second dichroic mirror 31 divides the blue light included in the light exiting first dichroic mirror 29 into the s-polarization component and the p-polarization component of the blue light, and combines: the yellow light generated by exciting the phosphor plate by the s-polarization component of the blue light; the p-polarization component of the blue light; and the red light included in the light exiting first dichroic mirror 29. First phase difference plate 28 controls the ratio of the s-polarization component to the p-polarization component of the blue light entering from blue light source element 20.

In other words, light source device 100 has characteristics in that before combining the blue light with a relatively high intensity obtained from blue light source element 20 with red light, the ratio of the polarization components of the blue light is changed by first phase difference plate 28, and the blue light is polarized and divided by posterior-located second dichroic mirror 31, and part of the blue light (s-polarization component) is used for excitation of phosphor layer 35, and the remaining blue light (p-polarization component) is used as illumination light.

Accordingly, light source device 100 has a reduced size, and is capable of generating output light with a wider color gamut compared with a conventional technique.

According to the first embodiment, first phase difference plate 28 may be rotatably supported about the optical axis extending from blue light source element 20 to first dichroic mirror 29.

Accordingly, by rotating first phase difference plate 28, the white balance of the output light of light source device 100 can be easily adjusted.

According to the first embodiment, first phase difference plate 28 may be a ¼ waveplate or a ½ waveplate. According to the first embodiment, first phase difference plate 28 may include a substrate having an uneven pattern formed so as to generate birefringence. According to the first embodiment, first phase difference plate 28 may include a substrate, and a thin coat made of a dielectric material obliquely vapor-deposited on the surface of the substrate so as to generate birefringence.

Accordingly, a phase difference can be generated between the mutually orthogonal polarization components of the incident light.

According to the first embodiment, light source device 100 may further include: second phase difference plate 40 for changing the polarization state of the incident light; and reflective plate 41. In this case, second dichroic mirror 31, second phase difference plate 40, and reflective plate 41 are arranged such that the p-polarization component of the blue light and the red light entering second dichroic mirror 31 from first dichroic mirror 29 enter reflective plate 41 from second dichroic mirror 31 via second phase difference plate 40, and after being reflected by reflective plate 41, enter again second dichroic mirror 31 via second phase difference plate 40 and are combined with yellow light.

Accordingly, it is possible to combine light of different color components.

According to the first embodiment, second phase difference plate 40 may be a ¼ waveplate which operates over a band including blue light and red light. According to the first embodiment, second phase difference plate 40 may include a substrate having an uneven pattern formed so as to generate birefringence. According to the first embodiment, second phase difference plate 40 may include a substrate, and a thin coat made of a dielectric material obliquely vapor-deposited on the surface of the substrate so as to generate birefringence.

Accordingly, the phase difference can be generated between the mutually orthogonal polarization components of the incident light.

According to the first embodiment, each of blue light source element 20 and red light source element 24 may be a semiconductor laser element.

Accordingly, it is possible to obtain output light with wide color gamut spectral characteristics.

According to the first embodiment, the light exiting blue light source element 20 and the light exiting red light source element 24 may be linearly polarized.

Accordingly, light of different color components can be divided and combined by first dichroic mirror 29 and second dichroic mirror 31.

According to the first embodiment, the phosphor plate may include circular substrate 34 rotary driven and phosphor layer 35 disposed on circular substrate 34.

Accordingly, the temperature rise of the phosphor caused by excitation by the blue light can be reduced, and the phosphor conversion efficiency can be steadily maintained.

According to the first embodiment, the phosphor layer may include a Ce-activated YAG phosphor which generates yellow fluorescent light including green light and red light by being excited by blue light.

Accordingly, the phosphor layer is capable of generating yellow light including the color components of green light and red light by being excited by the blue light.

### Second Embodiment

The light source device according to the first embodiment is applicable to, for example, a projection display apparatus. In a second embodiment, the case will be described where active-matrix transmissive liquid crystal panels which operate in a twisted nematic (TN) mode or a vertical alignment (VA) mode as light modulators and which include thin coat transistors in pixel regions are used.

### [2-1. Configuration]

FIG. 5 schematically illustrates a configuration of projection display apparatus 120 according to the second embodiment. Projection display apparatus 120 in FIG. 5 includes: light source device 100; first lens array plate 200; second lens array plate 201; polarization conversion element 202; superimposing lens 203; blue-reflective dichroic mirror 204; green-reflective dichroic mirror 205; reflective mirrors 206, 207, and 208; relay lenses 209 and 210; field lenses 211, 212, and 213; incident-side polarization plates 214, 215, and 216; liquid crystal panels 217, 218, and 219; exit-side polarization plates 220, 221, and 222; color combining prism 223; and projection optical system 224.

Light source device 100 in FIG. 5 is light source device 100 according to the first embodiment.

The white light emitted form light source device 100 enters first lens array plate 200 including a plurality of lens elements. The light flux entering first lens array plate 200 is divided into a plurality of light fluxes. The divided light fluxes converge on second lens array plate 201 including a plurality of lens elements. The lens elements of first lens array plate 200 have aperture shapes similar to the shapes of liquid crystal panels 217 to 219. The focal length of each lens element of second lens array plate 201 is determined such that first lens array plate 200 and liquid crystal panels 217 to 219 have substantially a conjugate relation. The light exiting second lens array plate 201 enters polarization conversion element 202.

Polarization conversion element 202 includes a polarization splitting prism and a ½ waveplate, and converts natural light from the light source into light having one polarization direction. Since fluorescent light is natural light, polarization conversion element 202 converts the natural light into light in one polarization direction. Since the p-polarized blue light enters polarization conversion element 202, the blue light is converted into s-polarized light. The light exiting polarization conversion element 202 enters superimposing lens 203.

Superimposing lens 203 is a lens for illuminating liquid crystal panels 217 to 219 in a superimposed manner with the light exiting each lens element of second lens array plate 201.

First lens array plate 200 and second lens array plate 201, polarization conversion element 202, and superimposing lens 203 are referred to as an illumination optical system.

The light exiting superimposing lens 203 is divided into blue light, green light, and red light by blue-reflective dichroic mirror 204 and green-reflective dichroic mirror 205 which are color separation means. The green light passes through field lens 211 and incident-side polarization plate 214, and enters liquid crystal panel 217. The blue light is reflected by reflective mirror 206, passes through field lens 212, and incident-side polarization plate 215, and then enters liquid crystal panel 218. The red light passes through relay lenses 209 and 210 while being refracted, are reflected by reflective mirrors 207 and 208, passes through field lens 213 and incident-side polarization plate 216, and then enters liquid crystal panel 219.

Incident-side polarization plates 214 to 216 and exit-side polarization plates 220 to 222 are disposed on both sides of liquid crystal panels 217 to 219 such that these plates are orthogonal to the transmission axes. Liquid crystal panels 217 to 219 control voltage to be applied to each pixel according to an image signal so that the polarization state of the incident light is changed to be spatially modulated and image light of green, blue and red are formed.

Color combining prism 223 includes a red-reflective dichroic mirror and a blue-reflective dichroic mirror. Among the image light of each color passing through exit-side polarization plates 220 to 222, the green light passes through color combining prism 223, the red light is reflected by red-reflective dichroic mirror of color combining prism 223, and the blue light is reflected by the blue-reflective dichroic mirror of color combining prism 223. Accordingly, the green light which has passed through color combining prism 223 is combined with the reflected red light and blue light, and enters projection optical system 224. The light entering projection optical system 224 is enlarged and projected onto the screen (not illustrated).

Light source device 100 has a reduced size by using blue light source unit 22 and red light source unit 26, and outputs white light with a high color purity and excellent white balance. Accordingly, it is possible to achieve a small projection display apparatus with a wide color gamut. Moreover, three liquid crystal panels 217 to 219, which use polarization instead of a time-division method, are used as light modulators. Hence, it is possible to obtain a projected image with excellent color reproduction, no color braking, high brightness and high precision. Moreover, no total internal reflection prism is required, and the color combining prism is a small prism where light enters at 45 degrees. Hence, compared with the case where three DMD elements are used as light modulators, the size of the projection display apparatus can be reduced.

As described above, light source device 100 combines the blue light and the red light by using first dichroic mirror 29, divides the blue light into respective polarization components by using second dichroic mirror 31, and combines the yellow light generated by phosphor wheel device 37 and the blue light and the red light by using second dichroic mirror 31. Accordingly, it is possible to provide small projection display apparatus 120 including light source device 100.

As described above, according to the second embodiment, small projection display apparatus 120 including light source device 100 is capable of providing output light having spectral characteristics in which the color purity of three primary colors of blue, green and red is high, the color gamut is wide, and white balance is excellent.

In the second embodiment, the case has been described where transmissive liquid crystal panels are used as the light modulators. However, reflective liquid crystal panels may be used. Use of the reflective liquid crystal panels leads to a projection display apparatus with a reduced size and a higher precision.

### [2-2. Advantageous Effects Etc.]

According to the second embodiment, projection display apparatus 120 includes: light source device 100 according to the first embodiment; light modulators which spatially modulate incident light according to an image signal; an illumination optical system which emits the light exiting light source device 100 to the light modulators; and a projection optical system which projects the light exiting the light modulators. The light modulators are liquid crystal panels 217, 218, and 219.

Accordingly, by using light source device 100 according to the first embodiment which has a reduced size and is capable of outputting light with a wider color gamut compared with a conventional technique, the size of the projection display apparatus according to the second embodiment can be reduced compared with a conventional technique.

### Third Embodiment

In a third embodiment, the case will be described where digital micromirror devices (DMDs) are used as light modulators.

### [3-1. Configuration]

FIG. 6 schematically illustrates a configuration of projection display apparatus 130 according to the third embodiment. Projection display apparatus 130 in FIG. 6 includes: light source device 100; condensing lens 300; rod integrator 301; relay lens 302; reflective mirror 303; field lens 304; total internal reflection prism 305; air layer 306; color prism 307; blue-reflective dichroic mirror 308; red-reflective dichroic mirror 309; DMDs 310, 311, and 312; and projection optical system 313.

Light source device 100 in FIG. 6 is light source device 100 according to the first embodiment.

The white light emitted from light source device 100 enters condensing lens 300 and is condensed by rod integrator 301. The light entering rod integrator 301 is reflected within rod integrator 301 a plurality of times, so that the light intensity distribution is made uniform before exiting rod integrator 301. The light exiting rod integrator 301 is condensed by relay lens 302, is reflected by reflective mirror 303, passes through field lens 304, and enters total internal reflection prism 305.

Total internal reflection prism 305 includes two prisms with thin air layer 306 formed between the adjacent surfaces of the two prisms. Air layer 306 totally reflects the light entering at an angle equal to or greater than a critical angle. The light exiting field lens 304 is reflected by the total internal reflection surface of total internal reflection prism 305 and enters color prism 307.

Color prism 307 includes three prisms, and includes blue-reflective dichroic mirror 308 and red-reflective dichroic mirror 309 on adjacent surfaces of the respective prisms. Blue-reflective dichroic mirror 308 and red-reflective dichroic mirror 309 of color prism 307 divide incident light into blue light, red light, and green light, and the divided light respectively enter DMDs 310 to 312.

DMDs 310 to 312 deflect micromirrors according to an image signal, and divide incident light into reflected light traveling toward projection optical system 313 and reflected light traveling toward outside the effective region of projection optical system 313. The light reflected by DMDs 310 to 312 pass through color prism 307 again.

The blue light, the red light and the green light divided in the process of passing through color prism 307 are combined and enter total internal reflection prism 305. The light entering total internal reflection prism 305 enters air layer 306 at an angle equal to or less than the critical angle, and thus, passes through total internal reflection prism 305 and enters projection optical system 313. In this way, the image light formed by DMDs 310 to 312 is enlarged and projected onto the screen (not illustrated).

The size of light source device 100 is reduced by using blue light source unit 22 and red light source unit 26, and light source device 100 outputs white light with a high color purity and excellent white balance. Accordingly, it is possible to achieve small projection display apparatus 130 with a wide color gamut. Moreover, since DMDs 310 to 312 are used as light modulators, it is possible to achieve a projection display apparatus with an improved light resistance and improved heat resistance compared with the case where liquid crystal panels are used as the light modulators. Moreover, since three DMDs 310 to 312 are used, a projected image with excellent color reproduction, high brightness and high precision can be obtained.

As described above, light source device 100 combines the blue light and the red light by using first dichroic mirror 29, divides the blue light into respective polarization components by using second dichroic mirror 31, and combines the yellow light generated by phosphor wheel device 37 and the blue light and the red light by using second dichroic mirror 31. Accordingly, it is possible to provide small projection display apparatus 130 including light source device 100.

As described above, according to the third embodiment, small projection display apparatus 130 including light source device 100 is capable of providing output light having spectral characteristics in which the color purity of three primary colors of blue, green and red is high, the color gamut is wide, and white balance is excellent.

Although the case where three DMDs 310 to 312 are used as light modulators has been described in the third embodiment, only one DMD may be used. Use of one DMD leads to a smaller projection display apparatus.

### [3-2. Advantageous Effects Etc.]

According to the third embodiment, projection display apparatus 130 includes: light source device 100 according to the first embodiment; light modulators which spatially modulate the incident light according to an image signal; an illumination optical system which emits, to the light modulators, the light emitted from light source device 100; and a projection optical system which projects the light exiting the light modulators. The light modulators are digital micromirror devices 310, 311, and 312.

Accordingly, by using light source device 100 according to the first embodiment which has a reduced size and is capable of generating output light with a wider color gamut compared with a conventional technique, the size of projection display apparatus 130 according to the third embodiment can be reduced compared with a conventional technique.

### Other Embodiments

As described above, some embodiments have been described as examples of the technique of the present disclosure. However, the technique according to the present disclosure is not limited to such examples. The technique is also applicable to embodiments arrived at by making various modifications, interchanges, additions or omissions. Additionally, a new embodiment may be made by combining various structural elements described in the above described embodiments.

### INDUSTRIAL APPLICABILITY

The light source device according to the present disclosure is applicable to a projection display apparatus including a light modulator.

What is claimed is:

1. A light source device comprising:
a first light source element which generates blue light;
a second light source element which generates red light;
a first phase difference plate which controls a polarization component of the blue light;
a first light combiner which combines the blue light and the red light, the blue light entering from the first light source element via the first phase difference plate, the red light entering from the second light source element;
a second light combiner which the blue light and the red light combined by the first light combiner enter, the second light combiner dividing the blue light into a first polarization component and a second polarization component of the blue light;
a phosphor plate which generates yellow light by being excited by the first polarization component of the blue light;
a second phase difference plate which controls polarization of the second polarization component of the blue light and the red light; and
a reflective plate which reflects incident light,
wherein the second polarization component of the blue light and the red light enter the reflective plate from the second light combiner via the second phase difference plate, are reflected by the reflective plate, enter the second light combiner again via the second phase difference plate, and are combined with the yellow light.

2. The light source device according to claim 1,
wherein the first phase difference plate is supported rotatably about an optical axis extending from the first light source element to the first light combiner.

3. The light source device according to claim 1,
wherein the first phase difference plate is a ¼ waveplate or a ½ waveplate.

4. The light source device according to claim 1,
wherein the first phase difference plate includes a substrate having an uneven pattern formed so as to generate birefringence.

5. The light source device according to claim 1,
wherein the first phase difference plate includes a substrate and a thin coat made of a dielectric material obliquely vapor-deposited on a surface of the substrate so as to generate birefringence.

6. The light source device according to claim 1,
wherein each of the first light combiner and the second light combiner is a dichroic mirror.

7. The light source device according to claim 6,
wherein the second phase difference plate is a ¼ waveplate which operates over a band including blue light and red light.

8. The light source device according to claim 6,
wherein the second phase difference plate includes a substrate having an uneven pattern formed so as to generate birefringence.

9. The light source device according to claim 6,
wherein the second phase difference plate includes a substrate and a thin coat made of a dielectric material obliquely vapor-deposited on a surface of the substrate so as to generate birefringence.

10. The light source device according to claim 1,
wherein each of the first light source element and the second light source element is a semiconductor laser element.

11. The light source device according to claim 1,
wherein light emitted from the first light source element and light emitted from the second light source element are linearly polarized.

12. The light source device according to claim 1,
wherein the phosphor plate includes:
a circular substrate which is rotary driven; and
a phosphor layer disposed on the circular substrate.

13. The light source device according to claim 12,
wherein the phosphor layer includes a Ce-activated YAG phosphor which generates fluorescent light by being excited by the blue light, the fluorescent light being the yellow light which includes green light and red light.

14. A projection display apparatus comprising:
the light source device according to claim 1;
a light modulator which spatially modulates incident light according to an image signal;
an illumination optical system which emits, to the light modulator, light emitted from the light source device; and
a projection optical system which projects light exiting the light modulator.

15. The projection display apparatus according to claim 14,
wherein the light modulator is a liquid crystal panel.

16. The projection display apparatus according to claim 14,
wherein the light modulator is a digital micromirror device.
